(19) United States
(12) Patent Application Publication
(10) Pub. No.: US 2025/0148716 A1
(43) Pub. Date: May 8, 2025

(54) METHOD FOR 3-DIMENSION MODEL RECONSTRUCTION BASED ON MULTI-VIEW IMAGES AND APPARATUS FOR THE SAME

(71) Applicants: Electronics and Telecommunications Research Institute, Daejeon (KR); KWANGWOON UNIVERSITY INDUSTRY-ACADEMIC COLLABORATION FOUNDATION, Seoul (KR)

(72) Inventors: Hee Kyung LEE, Daejeon (KR); Gi Mun UM, Daejeon (KR); Ju Yong CHANG, Seoul (KR); Seung Young NOH, Seoul (KR); Jin Gyu HONG, Seoul (KR)

(73) Assignees: Electronics and Telecommunications Research Institute, Daejeon (KR); KWANGWOON UNIVERSITY INDUSTRY-ACADEMIC COLLABORATION FOUNDATION, Seoul (KR)

(21) Appl. No.: 18/934,551

(22) Filed: Nov. 1, 2024

(30) Foreign Application Priority Data
Nov. 3, 2023 (KR) 10-2023-0151166
Sep. 25, 2024 (KR) 10-2024-0130128

(51) Int. Cl. G06T 17/20; G06T 7/33; G06T 7/593; G06T 15/04

(52) U.S. Cl. CPC G06T 17/20; G06T 7/344; G06T 7/593; G06T 15/04; G06T 2200/04

(57) ABSTRACT

The present disclosure relates to a method for reconstructing a three-dimensional model based on a multi-view image and a device therefor. A method for reconstructing a three-dimensional model according to an embodiment of the present disclosure may include obtaining n (n>1) multi-view images, and a first two-dimensional feature map and a first three-dimensional feature map, based on n depth maps for the n multi-view images; estimating a mesh through occupancy prediction based on the first two-dimensional feature map and the first three-dimensional feature map; and applying a texture estimated based on a second two-dimensional feature map and a second three-dimensional feature map obtained based on the n multi-view images and the n depth maps to the estimated mesh to obtain a texture-applied final model.

### CROSS-REFERENCE TO RELATED APPLICATIONS

This application claims the benefit of earlier filing date and right of priority to Korean Application No. 10-2023-0151166, filed on Nov. 3, 2023, and Korean Application No. 10-2024-0130128, filed on Sep. 25, 2024, the contents of which are all hereby incorporated by reference herein in their entirety.

### TECHNICAL FIELD

The present disclosure relates to the reconstruction of a three-dimensional model, and more particularly, to a method for reconstructing a three-dimensional model based on a multi-view image and a device therefor.

### BACKGROUND ART

Research is being conducted to reconstruct a three-dimensional (3D) model from an image. For example, a 3D model may be a 3D human mesh, and reconstruction of a 3D human mesh may be performed to predict an accurate 3D mesh that includes the pose of a clothed human object, the shape of clothes, etc. Since the existing 3D model reconstruction methods use only a single image as an input, an inaccurate prediction may be performed for a part that is not expressed in an image.

In order to predict a part that is not expressed in a single image, methods for extracting a 3D feature map or predicting a 3D depth map are being proposed. Since the previously proposed technologies assume a single input image, there is a problem that reconstruction performance for the opposite side that is not expressed in an image is low. In order to solve this problem, a new technology that reconstructs a 3D model or estimates a 3D mesh based on multi-view images is required.

### SUMMARY

The present disclosure is to provide a method for reconstructing a 3D model based on multi-view images and a device therefor.

The present disclosure is to provide a method for performing occupancy prediction and texture prediction based on an implicit function in order to reconstruct a 3D model based on multi-view images and a device therefor.

The technical objects to be achieved by the present disclosure are not limited to the above-described technical objects, and other technical objects which are not described herein will be clearly understood by those skilled in the pertinent art from the following description.

A method for reconstructing a three-dimensional model according to an embodiment of the present disclosure may include obtaining n (n>1) multi-view images, and a first two-dimensional feature map and a first three-dimensional feature map, based on n depth maps for the n multi-view images; estimating a mesh through occupancy prediction based on the first two-dimensional feature map and the first three-dimensional feature map; and applying a texture estimated based on a second two-dimensional feature map and a second three-dimensional feature map obtained based on the n multi-view images and the n depth maps to the estimated mesh to obtain a texture-applied final model.

A device for reconstructing a three-dimensional model according to an additional embodiment of the present disclosure may include at least one processor; and at least one memory operably connected to the at least one processor and storing an instruction that makes the device perform an operation when executed by the at least one processor. The operation may include obtaining n (n>1) multi-view images, and a first two-dimensional feature map and a first three-dimensional feature map, based on n depth maps for the n multi-view images; estimating a mesh through occupancy prediction based on the first two-dimensional feature map and the first three-dimensional feature map; and applying a texture estimated based on a second two-dimensional feature map and a second three-dimensional feature map obtained based on the n multi-view images and the n depth maps to the estimated mesh to obtain a texture-applied final model.

In some embodiments of the present disclosure, the first two-dimensional feature map may correspond to n first improved two-dimensional feature maps based on n first pixel-aligned two-dimensional feature maps extracted based on the n multi-view images and the n depth maps.

In some embodiments of the present disclosure, the n first improved two-dimensional feature maps may be obtained through a feature-improved multi-layer perceptron for a i-th view, for each i (1≤i≤n)-th first pixel-aligned two-dimensional feature map of the n first pixel-aligned two-dimensional feature maps.

In some embodiments of the present disclosure, input of a feature-improved multi-layer perceptron for the i-th view may correspond to a bilinear interpolation result for a i-th first pixel-aligned two-dimensional feature map; and two-dimensional projection π(x) corresponding to a i-th view for a three-dimensional query coordinate x. A final dimension of each of the n first improved two-dimensional feature maps may be determined equally as 256/n.

In some embodiments of the present disclosure, the first three-dimensional feature map may correspond to a three-dimensional volume estimated through depth map backprojection based on the n multi-view images and the n depth maps; and a first voxel-aligned three-dimensional feature map transformed through first three-dimensional feature extraction for the estimated three-dimensional volume.

In some embodiments of the present disclosure, the depth map backprojection may include performing deconvolution on an image feature map based on the n multi-view images and the n depth maps; obtaining a three-dimensional image feature map through repetition and concatenation for an image feature map to which deconvolution is applied; and estimating the three-dimensional volume through three-dimensional convolution for the three-dimensional image feature map.

In some embodiments of the present disclosure, a predetermined number of points may be extracted from the estimated three-dimensional volume, and the first voxel-aligned three-dimensional feature map may be obtained based on the predetermined number of points.

In some embodiments of the present disclosure, the occupancy prediction may include outputting a value estimating whether a three-dimensional query coordinate x is inside or outside the three-dimensional model through an occupancy prediction multi-layer perceptron based on a two-dimensional feature map for occupancy prediction in which the n first improved two-dimensional feature maps are fused; and the first three-dimensional feature map.

In some embodiments of the present disclosure, the first two-dimensional feature map may include a geometric feature for the n multi-view images and the n depth maps, the second two-dimensional feature map may include a texture-related feature for the n multi-view images and the n depth maps, the first three-dimensional feature map may be obtained based on a textureless three-dimensional volume, and the second three-dimensional feature map may be obtained based on a textured three-dimensional volume.

In some embodiments of the present disclosure, the n depth maps may be estimated based on the n multi-view images; and a mesh estimated based on a first image among the n multi-view images.

A method for reconstructing a three-dimensional model according to an additional embodiment of the present disclosure may include obtaining n (n>1) multi-view images, and a second two-dimensional feature map and a second three-dimensional feature map, based on n depth maps for the n multi-view images; estimating a texture through texture prediction based on the second two-dimensional feature map and the second three-dimensional feature map; and applying the estimated texture to a mesh estimated based on a first two-dimensional feature map and a first three-dimensional feature map obtained based on the n multi-view images and the n depth maps to obtain a texture-applied final model.

A device for reconstructing a three-dimensional model according to an additional embodiment of the present disclosure may include at least one processor; and at least one memory operably connected to the at least one processor and storing an instruction that makes the device perform an operation when executed by the at least one processor. The operation may include obtaining n (n>1) multi-view images, and a second two-dimensional feature map and a second three-dimensional feature map, based on n depth maps for the n multi-view images; estimating a texture through texture prediction based on the second two-dimensional feature map and the second three-dimensional feature map; and applying the estimated texture to a mesh estimated based on a first two-dimensional feature map and a first three-dimensional feature map obtained based on the n multi-view images and the n depth maps to obtain a texture-applied final model.

In some embodiments of the present disclosure, the second two-dimensional feature map may correspond to n improved two-dimensional feature maps based on n second pixel-aligned two-dimensional feature maps extracted based on the n multi-view images and the n depth maps.

In some embodiments of the present disclosure, the n second improved two-dimensional feature maps may be obtained through a feature-improved multi-layer perceptron for a i-th view, for each i (1≤i≤n)-th second pixel-aligned two-dimensional feature map of the n second pixel-aligned two-dimensional feature maps.

In some embodiments of the present disclosure, input of a feature-improved multi-layer perceptron for the i-th view may correspond to a bilinear interpolation result for a i-th second pixel-aligned two-dimensional feature map; and two-dimensional projection π(x) corresponding to a i-th view for a three-dimensional query coordinate x. A final dimension of each of the n second improved two-dimensional feature maps may be determined equally as 256/n.

In some embodiments of the present disclosure, the second three-dimensional feature map may correspond to a color three-dimensional volume estimated through color image backprojection based on the n multi-view images and the n depth maps; and a second voxel-aligned three-dimensional feature map transformed through second three-dimensional feature extraction for the estimated color three-dimensional volume.

In some embodiments of the present disclosure, a two-dimensional feature map for texture prediction may be obtained by fusing a feature map in which the n second improved two-dimensional feature maps are fused; and a two-dimensional feature map for occupancy prediction in which n first improved two-dimensional feature maps are fused.

In some embodiments of the present disclosure, the texture prediction may include obtaining a predicted red green blue (RGB) value for a three-dimensional query coordinate x, a first combining parameter λ, and a union of n second combining parameters ω₁, ω₂, . . . , ωₙ through a texture prediction multi-layer perceptron based on a two-dimensional feature map for the texture prediction; and the second three-dimensional feature map.

In some embodiments of the present disclosure, the estimated texture may be obtained by linearly combining the predicted RGB value; and an observed RGB value obtained based on the n multi-view images and the n second combining parameters ω₁, ω₂, . . . , ωₙ through the first combining parameter A.

The features briefly summarized above with respect to the present disclosure are just an exemplary aspect of a detailed description of the present disclosure described below, and do not limit a scope of the present disclosure.

According to the present disclosure, a method for reconstructing a 3D model based on multi-view images and a device therefor may be provided.

According to the present disclosure, a method for performing occupancy prediction and texture prediction based on an implicit function in order to reconstruct a 3D model based on multi-view images and a device therefor may be provided.

Effects achievable by the present disclosure are not limited to the above-described effects, and other effects which are not described herein may be clearly understood by those skilled in the pertinent art from the following description.

### BRIEF DESCRIPTION OF DRAWINGS

FIG. 1 is a block diagram of a three-dimensional model reconstruction device according to an embodiment of the present disclosure.

FIG. 2 is a flow diagram showing a three-dimensional model reconstruction method based on occupancy prediction according to an embodiment of the present disclosure.

FIG. 3 is a flow diagram showing a three-dimensional model reconstruction method based on texture prediction according to an embodiment of the present disclosure.

FIG. 4 is a block diagram of a three-dimensional model reconstruction device based on occupancy prediction according to an embodiment of the present disclosure.

FIG. 5 is a block diagram of a three-dimensional model reconstruction device based on texture prediction according to an embodiment of the present disclosure.

FIG. 6 is a detailed block diagram of a three-dimensional model reconstruction device according to an embodiment of the present disclosure.

FIG. 7 is a diagram for describing an example of depth map estimation.

FIG. 8 is a diagram for describing an example of depth map backprojection.

FIG. 9 is a diagram for describing an example of occupancy prediction.

FIG. 10 is a diagram showing an example of a structure of a feature-improved MLP.

FIG. 11 is a diagram showing examples of a qualitative result of multi-view image-based three-dimensional model estimation/reconstruction according to the present disclosure.

FIG. 12 is a diagram showing examples in which the improvement of a detailed feature may be confirmed from a qualitative result of multi-view image-based three-dimensional model estimation/reconstruction according to the present disclosure.

### DETAILED DESCRIPTION

As the present disclosure may make various changes and have multiple embodiments, specific embodiments are illustrated in a drawing and are described in detail in a detailed description. But, it is not to limit the present disclosure to a specific embodiment, and should be understood as including all changes, equivalents and substitutes included in an idea and a technical scope of the present disclosure. A similar reference numeral in a drawing refers to a like or similar function across multiple aspects. A shape and a size, etc. of elements in a drawing may be exaggerated for a clearer description. A detailed description on exemplary embodiments described below refers to an accompanying drawing which shows a specific embodiment as an example. These embodiments are described in detail so that those skilled in the pertinent art can implement an embodiment. It should be understood that a variety of embodiments are different each other, but they do not need to be mutually exclusive. For example, a specific shape, structure and characteristic described herein may be implemented in other embodiment without departing from a scope and a spirit of the present disclosure in connection with an embodiment. In addition, it should be understood that a position or an arrangement of an individual element in each disclosed embodiment may be changed without departing from a scope and a spirit of an embodiment. Accordingly, a detailed description described below is not taken as a limited meaning and a scope of exemplary embodiments, if properly described, are limited only by an accompanying claim along with any scope equivalent to that claimed by those claims.

In the present disclosure, a term such as first, second, etc. may be used to describe a variety of elements, but the elements should not be limited by the terms. The terms are used only to distinguish one element from other element. For example, without getting out of a scope of a right of the present disclosure, a first element may be referred to as a second element and likewise, a second element may be also referred to as a first element. A term of “and/or” includes a combination of a plurality of relevant described items or any item of a plurality of relevant described items.

When an element in the present disclosure is referred to as being “connected” or “linked” to another element, it should be understood that it may be directly connected or linked to that another element, but there may be another element between them. Meanwhile, when an element is referred to as being “directly connected” or “directly linked” to another element, it should be understood that there is no another element between them.

As construction units shown in an embodiment of the present disclosure are independently shown to represent different characteristic functions, it does not mean that each construction unit is composed in a construction unit of separate hardware or one software. In other words, as each construction unit is included by being enumerated as each construction unit for convenience of a description, at least two construction units of each construction unit may be combined to form one construction unit or one construction unit may be divided into a plurality of construction units to perform a function, and an integrated embodiment and a separate embodiment of each construction unit are also included in a scope of a right of the present disclosure unless they are beyond the essence of the present disclosure.

A term used in the present disclosure is just used to describe a specific embodiment, and is not intended to limit the present disclosure. A singular expression, unless the context clearly indicates otherwise, includes a plural expression. In the present disclosure, it should be understood that a term such as “include” or “have”, etc. is just intended to designate the presence of a feature, a number, a step, an operation, an element, a part or a combination thereof described in the present specification, and it does not exclude in advance a possibility of presence or addition of one or more other features, numbers, steps, operations, elements, parts or their combinations. In other words, a description of “including” a specific configuration in the present disclosure does not exclude a configuration other than a corresponding configuration, and it means that an additional configuration may be included in a scope of a technical idea of the present disclosure or an embodiment of the present disclosure.

Some elements of the present disclosure are not a necessary element which performs an essential function in the present disclosure and may be an optional element for just improving performance. The present disclosure may be implemented by including only a construction unit which is necessary to implement essence of the present disclosure except for an element used just for performance improvement, and a structure including only a necessary element except for an optional element used just for performance improvement is also included in a scope of a right of the present disclosure.

Hereinafter, an embodiment of the present disclosure is described in detail by referring to a drawing. In describing an embodiment of the present specification, when it is determined that a detailed description on a relevant disclosed configuration or function may obscure a gist of the present specification, such a detailed description is omitted, and the same reference numeral is used for the same element in a drawing and an overlapping description on the same element is omitted.

Hereinafter, various embodiments of the present disclosure regarding a multi-view image-based three-dimensional model reconstruction method and device are described.

Recently, with the development of deep learning, research on reconstructing a 3D model (e.g., a 3D human mesh) from an image has been actively conducted. For example, a goal of research on clothed human reconstruction is to predict an accurate 3D mesh including a person's posture, the shape of clothes, etc. Among the existing human mesh reconstruction methods based on an implicit function, pixel-aligned implicit function for high-resolution clothed human digitization (PIFu) reconstructs a 3D mesh of a human object by utilizing a pixel-aligned feature map obtained by passing an input red green blue (RGB) image through a 2D encoder. However, since PIFu uses only a single image as an input, prediction for an invisible part is inaccurate. In order to overcome this, parametric model-conditioned implicit representation for image-based human reconstruction (PaMIR) estimates a skinned multi-person linear (SMPL) model/mesh representing the entire body through convolutional mesh regression for single-image human shape reconstruction (GraphCMR) and passes an estimated 3D mesh through a 3D encoder to extract a 3D feature map. It is combined with a 2D pixel-aligned feature map obtained from a 2D encoder to predict a final 3D mesh. Depth-guided implicit function for clothed human reconstruction (DIFu) learns a hallucinator to generate an invisible opposite image from an input image. In addition, it predicts a depth map corresponding to an input image and a generated opposite image through a learned depth estimation network. Predicted depth maps are backprojected into 3D space to generate a 3D voxel. The input and generated opposite images and estimated depth maps are input to a 2D encoder and a 3D voxel is input to a 3D encoder to predict a final 3D mesh. Since all of these methods assume a single input image, they show a tendency of a deterioration in reconstruction performance for an invisible opposite part.

In the present disclosure, various examples for a method and a device for estimating a 3D model (e.g., a human mesh) from a multi-view image calibrated by extending the existing DIFu are described. In the examples of the present disclosure, an actual image of a multi-view is used, so a deterioration in reconstruction performance for an invisible part is prevented, enabling more delicate and accurate 3D mesh reconstruction.

Although the present disclosure is mainly described in terms of improving the performance and problems of clothed human reconstruction, the scope of the present disclosure is not limited thereto, and may be applied to various fields for reconstructing an arbitrary 3D model based on multi-view images. Specifically, detailed examples of depth map backprojection and implicit function-based occupancy prediction and texture prediction using a multi-view image according to the present disclosure may also be applied equally to a variety of 3D model reconstructions.

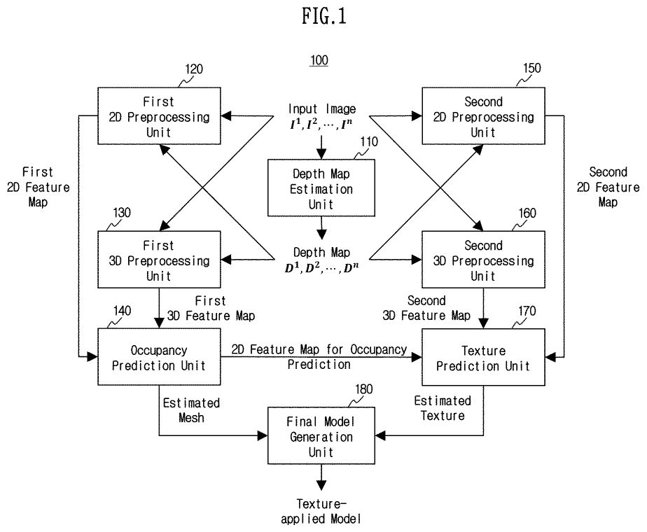

FIG. 1 is a block diagram of a three-dimensional model reconstruction device according to an embodiment of the present disclosure.

A three-dimensional model reconstruction device (100) may include a depth map estimation unit (110) that estimates n depth maps D¹, D², . . . , Dⁿ based on n (n>1) input images (i.e., multi-view images) I¹, I², . . . , Iⁿ. For example, n depth maps D¹, D², . . . , Dⁿ may be estimated based on a mesh (e.g., a SMPL mesh estimated based on a single image) estimated based on n multi-view images I¹, I², . . . , Iⁿ, and a first image (e.g., I¹) among the n multi-view images I¹, I², . . . , Iⁿ.

These n input images I¹, I², . . . , Iⁿ and n depth maps D¹, D², . . . , Dⁿ may be provided as an input to a first 2D (two-dimensional) preprocessing unit (120), a first 3D (three-dimensional) preprocessing unit (130), a second two-dimensional preprocessing unit (150) and a third three-dimensional preprocessing unit (160).

A first two-dimensional preprocessing unit (120) may provide an occupancy prediction unit (140) with a first two-dimensional feature map including a geometric feature for the above-described inputs. A first three-dimensional preprocessing unit (130) may provide an occupancy prediction unit (140) with a first three-dimensional feature map obtained based on a textureless three-dimensional volume for the above-described inputs. An occupancy prediction unit (140) may provide a mesh estimated based on these inputs to a final model generation unit (180).

A second two-dimensional preprocessing unit (150) may provide a texture prediction unit (170) with a second two-dimensional feature map including a texture-related feature for the above-described inputs. A second three-dimensional preprocessing unit (160) may provide a texture prediction unit (170) with a second three-dimensional feature map obtained based on a textured three-dimensional volume for the above-described inputs. A texture prediction unit (170) may provide a final model generation unit (180) with a texture estimated based on these inputs. Additionally, a texture prediction unit (170) may receive a 2D feature map for occupancy prediction provided from an occupancy prediction unit (140) as an input and utilize it for texture estimation.

A final model generation unit (180) may apply a texture to a provided mesh to generate a texture-applied model.

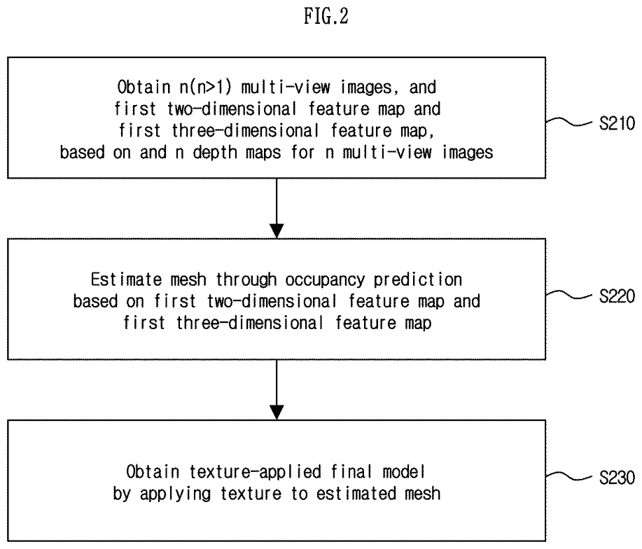

FIG. 2 is a flow diagram showing a three-dimensional model reconstruction method based on occupancy prediction according to an embodiment of the present disclosure.

In S210, a device may obtain a first two-dimensional feature map and a first three-dimensional feature map based on n (n>1) multi-view images, and n depth maps for n multi-view images.

A first two-dimensional feature map may include a geometric feature for n multi-view images and n depth maps. A first three-dimensional feature map may be obtained based on a textureless three-dimensional volume.

A first two-dimensional feature map may correspond to n first improved two-dimensional feature maps \tilde{F}_{SH}¹, \tilde{F}_{SH}², . . . , \tilde{F}_{SH}ⁿ based on n first pixel-aligned two-dimensional feature maps F_{SH}¹, F_{SH}², . . . , F_{SH}ⁿ extracted based on n multi-view images I¹, I², . . . , Iⁿ and n depth maps D¹, D², . . . , Dⁿ.

In addition, for each i (1≤i≤n)-th first pixel-aligned two-dimensional feature map F_{SH}ⁱ of n first pixel-aligned two-dimensional feature maps F_{SH}¹, F_{SH}², . . . , F_{SH}ⁿ, n first improved two-dimensional feature maps \tilde{F}_{SH}¹, \tilde{F}_{SH}², . . . , \tilde{F}_{SH}ⁿ may be obtained through a feature-improved multi-layer perceptron f_{RF}ⁱ for a i-th view.

Here, an input of a feature-improved multi-layer perceptron f_{RF}ⁱ for a i-th view may correspond to a bilinear interpolation result B (F_{SH}ⁱ, π(x)) for a i-th first pixel-aligned two-dimensional feature map F_{SH}ⁱ, and two-dimensional projection π(x) corresponding to a i-th view for a three-dimensional query coordinate x. In addition, a final dimension of each of the n first improved two-dimensional feature maps \tilde{F}_{SH}¹, \tilde{F}_{SH}², . . . , \tilde{F}_{SH}ⁿ may be determined equally as 256/n.

Next, a first three-dimensional feature map may correspond to a three-dimensional volume V estimated through depth map backprojection based on n multi-view images I¹, I², . . . , Iⁿ and n depth maps D¹, D², . . . , Dⁿ (i.e., a textureless three-dimensional volume) and a first voxel-aligned three-dimensional feature map F_{3D_OCC} transformed through first three-dimensional feature extraction (f_{3D_enc}) on an estimated three-dimensional volume V.

Here, depth map backprojection may include performing deconvolution on an image feature map F_{img} based on n multi-view images I¹, I², . . . , Iⁿ and n depth maps D¹, D², . . . , Dⁿ, obtaining a three-dimensional image feature map F_{feat3d} through repetition and concatenation for an image feature map F_{img} to which deconvolution is applied (i.e., resolution is increased), and then estimating a three-dimensional volume V through three-dimensional convolution on a three-dimensional image feature map F_{feat3d}. In addition, in order to compress information on an estimated three-dimensional volume V, a predetermined number of points may be extracted from a three-dimensional volume V, and a first voxel-aligned three-dimensional feature map F_{3D_OCC} may be obtained based on a predetermined number of points.

In S220, a device may estimate a mesh through occupancy prediction based on a first two-dimensional feature map and a first three-dimensional feature map.

Occupancy prediction may include outputting a value (e.g., 1 if inside or 0 if outside) estimating whether a three-dimensional query coordinate x is inside or outside a three-dimensional model (e.g., a three-dimensional human object) through an occupancy prediction multi-layer perceptron f_{OCC} based on a two-dimensional feature map F_{2D_OCC} for occupancy prediction in which n first improved two-dimensional feature maps \tilde{F}_{SH}¹, \tilde{F}_{SH}², . . . , \tilde{F}_{SH}ⁿ are fused, and a first three-dimensional feature map F_{3D_OCC}.

In S230, a device may apply a texture to an estimated mesh to obtain a texture-applied final model.

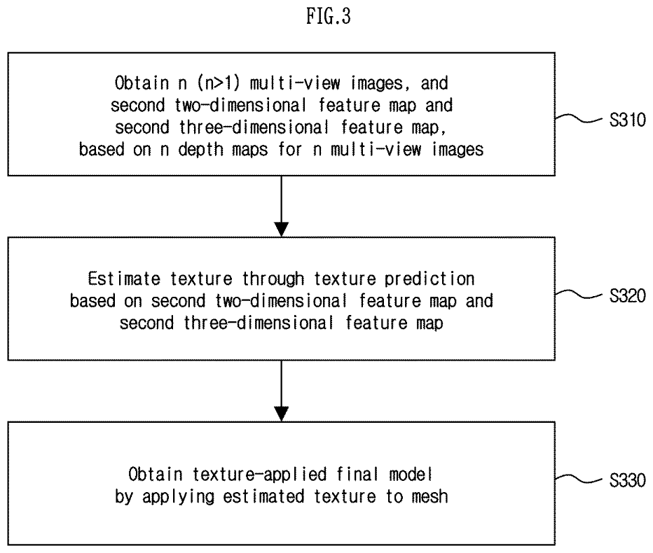

A texture may be estimated based on a second two-dimensional feature map and a second three-dimensional feature map obtained based on n multi-view images and n depth maps, and a specific description thereof is described later by referring to an example of FIG. 3.

This texture may also be applied to a flattened mesh to which flattening is applied to an estimated mesh.

FIG. 3 is a flow diagram showing a three-dimensional model reconstruction method based on texture prediction according to an embodiment of the present disclosure.

In S310, a device may obtain a second two-dimensional feature map and a second three-dimensional feature map based on n (n>1) multi-view images and n depth maps for n multi-view images.

A second two-dimensional feature map may include a texture-related feature for n multi-view images and n depth maps. A second three-dimensional feature map may be obtained based on a textured three-dimensional volume.

A second two-dimensional feature map may correspond to n second improved two-dimensional feature maps \tilde{F}_{CG}¹, \tilde{F}_{CG}², . . . , \tilde{F}_{CG}ⁿ based on n second pixel-aligned two-dimensional feature maps F_{CG}¹, F_{CG}², . . . , F_{CG}ⁿ extracted based on n multi-view images I¹, I², . . . , Iⁿ and n depth maps D¹, D², . . . , Dⁿ.

In addition, for each i (1≤i≤n)-th second pixel-aligned two-dimensional feature map F_{CH}ⁱ of n second pixel-aligned two-dimensional feature maps F_{CG}¹, F_{CG}², . . . , F_{CG}ⁿ, n second improved two-dimensional feature maps \tilde{F}_{CG}¹, \tilde{F}_{CG}², . . . , \tilde{F}_{CG}ⁿ may be obtained through a feature-improved multi-layer perceptron \acute{f}_{RF}ⁱ for a i-th view (which may have the same structure as a feature-improved multi-layer perceptron f_{RF}ⁱ related to occupancy prediction).

Here, an input of a feature-improved multi-layer perceptron f_{RF}ⁱ for a i-th view may correspond to a bilinear interpolation result B (F_{CG}ⁱ, π(x)) for a i-th second pixel-aligned two-dimensional feature map F_{CG}ⁱ, and two-dimensional projection π(x) corresponding to a i-th view for a three-dimensional query coordinate x. In addition, a final dimension of each of n second improved two-dimensional feature maps \tilde{F}_{CG}¹, \tilde{F}_{CG}², . . . , \tilde{F}_{CG}ⁿ may be determined equally as 256/n.

Next, a second three-dimensional feature map may correspond to a color three-dimensional volume V′ estimated through color image backprojection based on n multi-view images I¹, I², . . . , Iⁿ and n depth maps D¹, D², . . . , Dⁿ and a second voxel-aligned three-dimensional feature map F_{3D_TEX} transformed through second three-dimensional feature extraction (or backprojection on a three-dimensional space) for an estimated color three-dimensional volume V′.

In S320, a device may estimate a mesh through occupancy prediction based on a second two-dimensional feature map and a second three-dimensional feature map.

A second two-dimensional feature map, i.e., n second improved two-dimensional feature maps \tilde{F}_{CG}¹, \tilde{F}_{CG}², . . . , \tilde{F}_{CG}ⁿ may be fused to obtain F_{2D_TEX}. This fused feature map F_{2D_TEX} may be fused with a two-dimensional feature map F_{2D_OCC} for occupancy prediction described in an example of FIG. 2 to obtain a two-dimensional feature map F_{2D_FIN} for texture prediction.

Texture prediction may include obtaining a predicted RGB value (Ĉ) for a three-dimensional query coordinate x, a first combining parameter λ, and a union of n second combining parameters ω1, ω2, . . . , ωn through a texture prediction multi-layer perceptron f_{TEX} based on a two-dimensional feature map F_{2D_FIN} for texture prediction and the second three-dimensional feature map F_{3D_TEX}.

Next, an observed RGB value (C) may be obtained based on n multi-view images I¹, I², . . . , Iⁿ and n second combining parameters ω₁, ω₂, . . . , ωₙ.

An estimated texture may be obtained by linearly combining a predicted RGB value (Ĉ) and an observed RGB value (C) through a first combining parameter λ.

In S330, a device may apply an estimated texture to a mesh to obtain a texture-applied final model.

A mesh may be an estimated mesh as described above by referring to an example of FIG. 2 or may be a flattened mesh that flattening is applied to an estimated mesh.

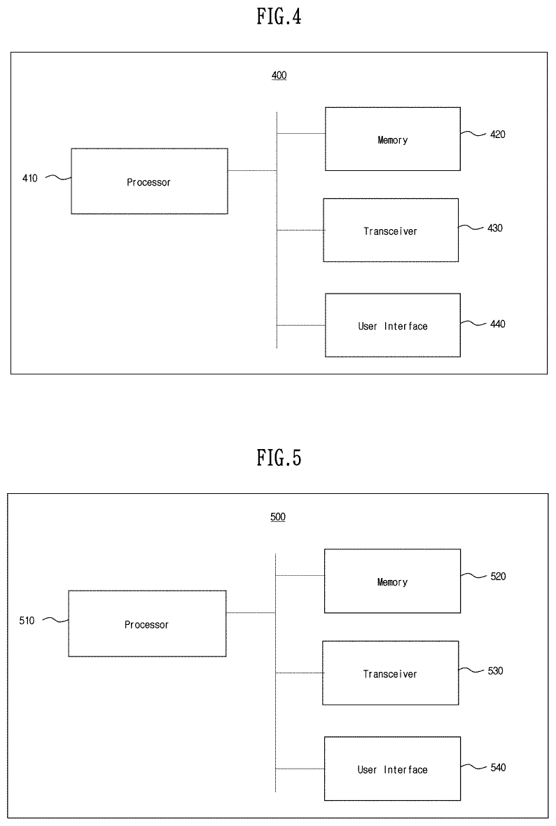

FIG. 4 is a block diagram of a three-dimensional model reconstruction device based on occupancy prediction according to an embodiment of the present disclosure.

A device (400) may include at least one processor (410), at least one memory (420), at least one transceiver (430), at least one user interface (440), etc. A memory (420) may be included in a processor (410) or may be configured separately. A memory (420) may store an instruction that makes a device (400) perform an operation when executed by a processor (410). A transceiver (430) may transmit and/or receive a signal, data, etc. that is exchanged by a device (400) with another entity. A user interface (440) may receive a user's input for a device (400) or provide the output of a device (400) to a user. Among the components of a device (400), components other than a processor (410) and a memory (420) may not be included in some cases, and other components not shown in FIG. 4 may be included in a device (400).

A processor (410) may be configured to make the above-described device (400) perform 3D model reconstruction according to various examples of the present disclosure. Although not shown in FIG. 4, a processor (410) may be configured as a set of modules that perform each function of a first two-dimensional feature map acquisition unit (including a first two-dimensional preprocessing unit (120) in FIG. 1), a first three-dimensional feature map acquisition unit (including a first three-dimensional preprocessing unit (130) in FIG. 1), an occupancy prediction unit (corresponding to an occupancy prediction unit (140) in FIG. 1) and a final model acquisition unit (corresponding to a final model generation unit (180) in FIG. 1). A module may be configured in the form of hardware and/or software. For example, a processor (410) may be configured to obtain a first two-dimensional feature map and a first three-dimensional feature map based on n (n>1) multi-view images and n depth maps for n multi-view images and estimate a mesh through occupancy prediction based on a first two-dimensional feature map and a first three-dimensional feature map. In addition, a processor (410) may be configured to receive/obtain an estimated texture based on a second two-dimensional feature map and a second three-dimensional feature map based on n multi-view images and n depth maps by a device (500) in FIG. 5. Based on this, a processor (410) may be configured to apply a received/obtained texture to an estimated mesh to obtain a texture-applied final model.

FIG. 5 is a block diagram of a three-dimensional model reconstruction device based on texture prediction according to an embodiment of the present disclosure.

A device (500) may include at least one processor (510), at least one memory (520), at least one transceiver (530), at least one user interface (540), etc. A memory (520) may be included in a processor (510) or may be configured separately. A memory (520) may store an instruction that makes a device (500) perform an operation when executed by a processor (510). A transceiver (530) may transmit and/or receive a signal, data, etc. that is exchanged by a device (500) with another entity. A user interface (540) may receive a user's input for a device (500) or provide the output of a device (500) to a user. Among the components of a device (500), components other than a processor (510) and a memory (520) may not be included in some cases, and other components not shown in FIG. 5 may be included in a device (500).

A processor (510) may be configured to make the above-described device (500) perform 3D model reconstruction according to various examples of the present disclosure. Although not shown in FIG. 5, a processor (510) may be configured as a set of modules that perform each function of a second two-dimensional feature map acquisition unit (including a second 2D preprocessing unit (150) in FIG. 1), a second three-dimensional feature map acquisition unit (including a second 3D preprocessing unit (160) in FIG. 1), a texture prediction unit (corresponding to a texture prediction unit (170) in FIG. 1) and a final model acquisition unit (corresponding to a final model generation unit (180) in FIG. 1). A module may be configured in the form of hardware and/or software. For example, a processor (510) may be configured to obtain a second two-dimensional feature map and a second three-dimensional feature map based on n (n>1) multi-view images and n depth maps for n multi-view images and estimate a texture through texture prediction based on a second two-dimensional feature map and a second three-dimensional feature map. In addition, a processor (510) may be configured to receive an estimated mesh based on a first two-dimensional feature map and a first three-dimensional feature map based on n multi-view images and n depth maps by a device (400) in FIG. 4. Based on this, a processor (510) may be configured to apply an estimated texture to a received/obtained mesh to obtain a texture-applied final model.

A device (400) in FIG. 4 and a device in FIG. 5 (500) may be implemented as a separate device or may be implemented by being merged as one device (e.g., a device (100) in FIG. 1). When they are merged as one device (100), a description for a processor (410) and a processor (510) may be implemented as being performed by one processor. In addition, an estimated mesh and an estimated texture may be obtained internally in one device (100).

Hereinafter, a detailed operation and feature of three-dimensional model reconstruction based on occupancy prediction and texture prediction are described by referring to an example of FIGS. 2 to 5.

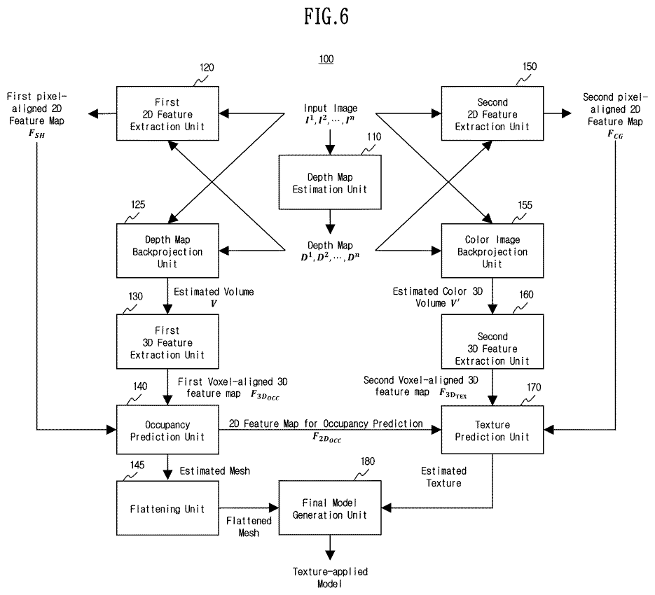

FIG. 6 is a detailed block diagram of a three-dimensional model reconstruction device according to an embodiment of the present disclosure.

As in an example of FIG. 6, a textured mesh may be finally estimated/generated from a multi-view input color image.

First, a depth map estimation unit (110) receives a multi-view color image as an input and estimates a depth map corresponding to each view. Afterwards, all of a first 2D feature extraction unit (120), a second 2D feature extraction unit (150), a depth map backprojection unit (125) and a color image backprojection unit (155) use a multi-view color image and an estimated depth map as an input.

A first 2D feature extraction unit (120) and a second 2D feature extraction unit (150) receive the same input and extract a different first pixel-aligned feature map (F_{SH}) and second pixel-aligned feature map (F_{CG}).

A first 2D feature extraction unit (120) may extract a geometry-related pixel-aligned feature through a first 2D encoder (e.g., a 2D encoder of Stacked Hourglass). A second 2D feature extraction unit (150) may extract a texture-related pixel-aligned feature through a second 2D encoder (e.g., a 2D encoder of CycleGan).

A depth map backprojection unit (125) may estimate a textureless 3D volume and a color image backprojection unit (155) may generate a textured 3D volume. Although an example of FIG. 1 and FIG. 6 shows that both a depth map backprojection unit (125) and a color image backprojection unit (155) receive a color image and a depth map as an input, the scope of the present disclosure is not limited thereto. In other words, a depth map backprojection unit (125) and a color image backprojection unit (155) may flexibly generate a 3D volume corresponding to each input by receiving a variety of inputs such as receiving only a depth map as an input, receiving only a color image as an input or receiving both a depth map and a color image as an input.

A textureless 3D volume V estimated through a depth map backprojection unit (125) may be extracted as a first voxel-aligned feature map F_{3D_OCC} through a first 3D feature extraction unit (130). A textured 3D volume V′ generated through a color image backprojection unit (155) may be extracted as a second voxel-aligned feature map F_{3D_TEX} through a second 3D feature extraction unit (160).

An occupancy prediction unit (140) may estimate a textureless mesh by receiving a first pixel-aligned feature map F_{SH} and a first voxel-aligned feature map F_{3D_OCC} as an input. An estimated mesh may be transformed into a flattened mesh through a flattening unit. A texture prediction unit (170) may estimate a texture by receiving a first pixel-aligned feature map F_{CG}, a 2D feature map F_{2D_OCC} for occupancy prediction from an occupancy prediction unit (140) and a second voxel-aligned feature map F_{3D_TEX} as an input. Afterwards, a textured mesh may be finally output by applying/putting a texture to a flattened mesh.

### Basic Assumption

A cubic space sized 2*2*2 m³ surrounding a 3D model (e.g., a human object) to be reconstructed in the present disclosure and a human-centered coordinate system aligned to a corresponding space are assumed. In addition, it may be assumed that through weak-perspective projection, a point (X,Y,Z) on a human-centered coordinate system is projected onto a point (x¹,y¹) on a first input image I¹ with the resolution of 512*512. For example, it may be expressed as in the following Equation.

$$[ \begin{matrix}{x}^{1} \\ {y}^{1}\end{matrix} ] = [ \begin{matrix}256 & 0 & 0 \\ 0 & 256 & 0\end{matrix} ] [ \begin{matrix}X \\ Y \\ Z\end{matrix} ] \qquad [ Equation 1 ]$$

For example, when it is assumed that n camera-view images are input, it may be assumed that a camera view of a i (1≤i≤n)-th image is rotated by 360°/n*(i−1) in a x-axis direction based on a y-axis. In the following description, it is assumed that 360°/n*(i−1) is θᵢ. Accordingly, a three-dimensional point (X, Y, Z) is projected onto a point (xⁱ,yⁱ) on a i-th input image Iⁱ through the following Equation.

$$[ \begin{matrix}{x}^{i} \\ {y}^{i}\end{matrix} ] = \{ \begin{matrix}[ \begin{matrix}256 * cos {θ}_{i} & 0 & 256 * sin {θ}_{i} \\ 0 & 256 & 0\end{matrix} ] [ \begin{matrix}X \\ Y \\ Z\end{matrix} ] , & if {θ}_{i} < 180 ° \\ [ \begin{matrix}256 * cos {θ}_{i} & 0 & 256 * sin {θ}_{i} \\ 0 & 256 & 0\end{matrix} ] [ \begin{matrix}X \\ Y \\ Z\end{matrix} ] + [ \begin{matrix}512 \\ 0\end{matrix} ] , & otherwise\end{matrix} \qquad [ Equation 2 ]$$

### Depth Map Estimation

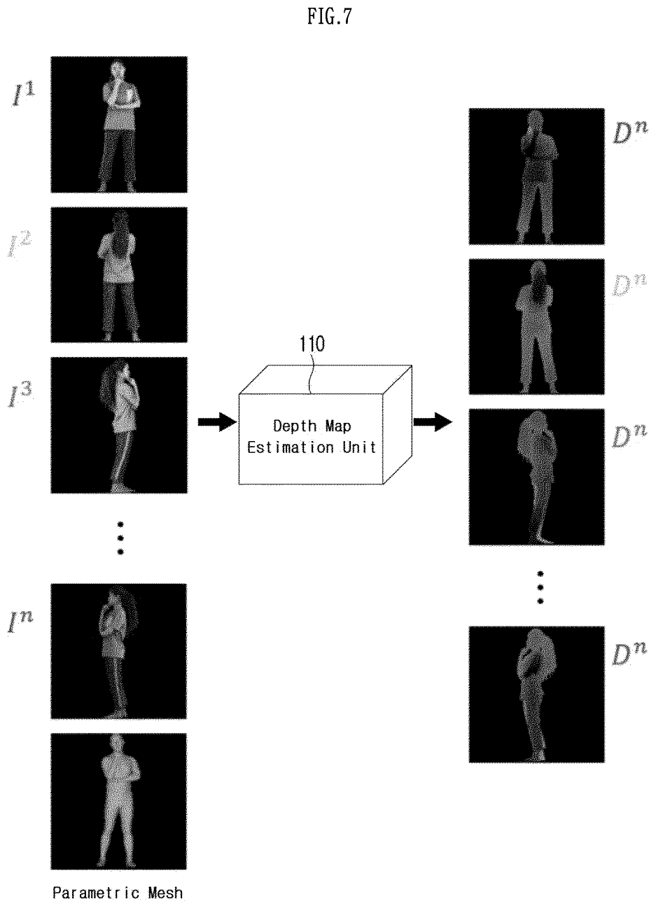

FIG. 7 is a diagram for describing an example of depth map estimation.

A depth map estimation unit (110) according to the present disclosure may estimate n depth maps by receiving n images and a SMPL mesh estimated through GraphCMR from a first image (e.g., I¹) among them as an input, as in an example of FIG. 7. As in the following Equation 3, n images I¹, I², . . . , Iⁿ may be transformed into a 2D feature map F_{U_2D} through an encoder f_{Uenc} of a convolutional neural network (CNN) (e.g., U-Net) for image segmentation.

$${f}_{{U}_{2 D}} = {f}_{{U}_{enc}} ( {I}^{1} , {I}^{2} , … , {I}^{n} ) \qquad [ Equation 3 ]$$

A SMPL mesh [symbol] may be transformed into a 3D feature map F_{V_3D} through a voxel encoder f_{Venc} as in the following Equation.

$${F}_{{V}_{3 D}} = {f}_{{V}_{enc}} ( 𝕍 ) \qquad [ Equation 4 ]$$

The above-described 2D feature map F_{U_2D} and 3D feature map F_{V_3D} may be used to estimate n depth maps D¹, D², . . . , Dⁿ through a decoder f_{Udec} of U-Net as in the following Equation.

$${D}^{1} , {D}^{2} , … , {D}^{n} = {f}_{{U}_{dec}} ( {F}_{{U}_{2 D}} , {F}_{{V}_{3 D}} ) \qquad [ Equation 5 ]$$

### Depth Map Backprojection

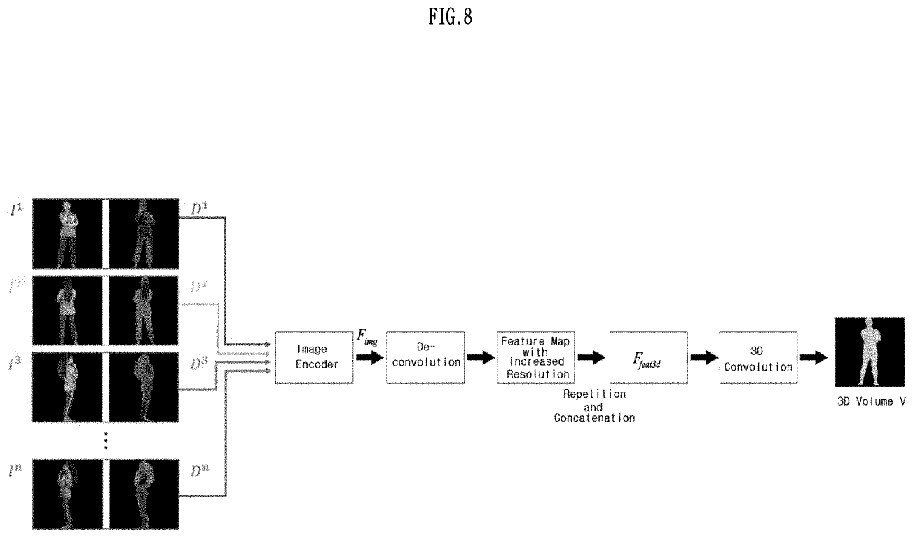

FIG. 8 is a diagram for describing an example of depth map backprojection.

A depth map backprojection unit (125) according to the present disclosure may predict a 3D volume V which will be used as prior information in an occupancy prediction unit (140) by receiving n input images I¹, I², . . . , Iⁿ and n depth maps D¹, D², . . . , Dⁿ estimated in a depth map estimation unit (110) as an input, as in an example of FIG. 8.

First, n input images I¹, I², . . . , Iⁿ and n estimated depth maps D¹, D², . . . , Dⁿ may be input to an image encoder f_{lenc} of a CNN (e.g., ResNet50) for image classification and transformed into a feature map F_{img} as in the following Equation.

$${F}_{img} = {f}_{{I}_{enc}} ( {I}^{1} , {I}^{2} , … , {I}^{n} , {D}^{1} , {D}^{2} , … , {D}^{n} ) \qquad [ Equation 6 ]$$

A feature map F_{img} obtained through an image encoder may be transformed into a 3D form through deconvolution and 3D convolution. For example, F_{img} may be used as an input of a deconvolution layer to increase the resolution of a feature map. A feature map with increased resolution (e.g., a mesh-out feature map) may be extended repeatedly by final resolution (e.g., 64), and a three-dimensional feature map (F_{feat3d}) may be obtained by concatenating an expanded feature map at a predetermined interval (e.g., by generating z with position information at a predetermined interval). Obtained F_{feat3d} may be used as an input of 3D convolution that reduces the number of channels. As in the following Equation, a network of a depth map backprojection unit (125) may be finally learned to output 1 when each point in a cubic space sized 64*64*64 is estimated to be inside a human object and to output 0 when it is estimated to be outside a human object.

$${F}_{3 {D}_{conv}} ( {F}_{feat 3 d} ) ↦ [ 0 , 1 ] \qquad [ Equation 7 ]$$

A 3D volume (or a 3D mesh) estimated by a depth map backprojection unit (125) may be used as an initial value for final prediction. A 3D volume estimated by a depth map backprojection unit (125) may include too much information to be used as prior information for learning an occupancy network for occupancy prediction. Accordingly, an arbitrary number of points may be sampled from a 3D volume predicted by a network of a depth map backprojection unit (125) and used in a subsequent first 3D feature extraction unit (130) and occupancy prediction unit (140).

3D volume/mesh estimation for 3D feature map extraction based on a depth map backprojection unit (125) according to the present disclosure is quantitatively and qualitatively accurate, so it may improve the performance of a final mesh prediction result and furthermore, it provides 3D mesh estimation performance that is not limited to the number of input images, so it may obtain a more improved voxel alignment feature as there are more input images.

### Occupancy Prediction

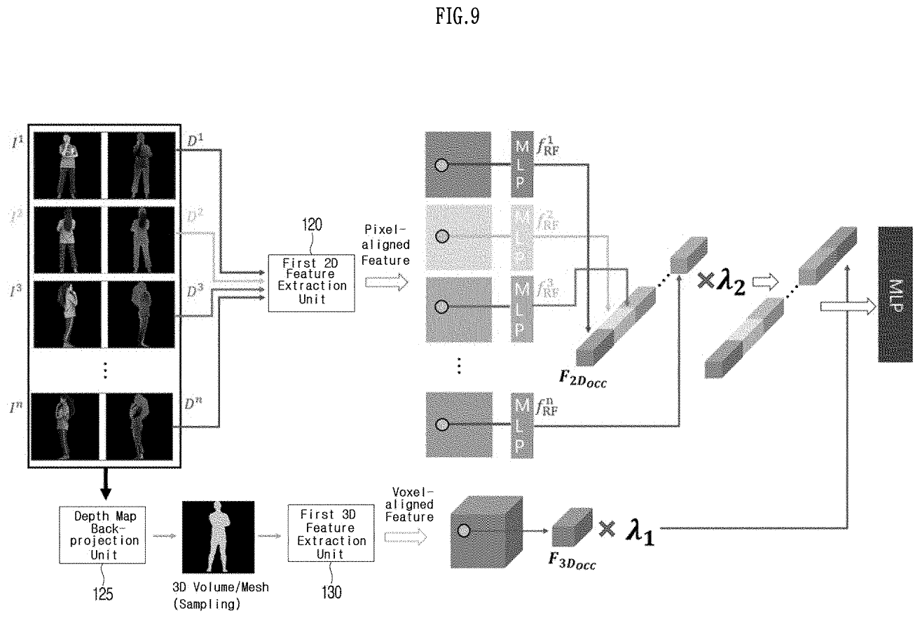

FIG. 9 is a diagram for describing an example of occupancy prediction.

An occupancy prediction unit (140) according to the present disclosure may predict an occupancy probability for a human object by receiving n input images I¹, I², . . . , Iⁿ, n depth maps D¹, D², . . . , Dⁿ estimated in a depth map estimation unit (110) and a 3D volume V generated in a depth map backprojection unit (125) as an input, as in an example of FIG. 9.

First, n input images I¹, I², . . . , Iⁿ and n estimated depth maps D¹, D², . . . , Dⁿ may be transformed into a first pixel-aligned 2D feature map F_{SH} by a first 2D feature extraction unit (120) (e.g., a 2D encoder f_{SHenc} of Stacked Hourglass) as in the following Equation.

$${F}_{SH} = {f}_{{SH}_{enc}} ( {I}^{1} , {I}^{2} , … , {I}^{n} , {D}^{1} , {D}^{2} , … , {D}^{n} ) \qquad [ Equation 8 ]$$

Here, all of n input images I¹, I², . . . , Iⁿ and n estimated depth maps D¹, D², . . . , Dⁿ may be concatenated and input to a 2D encoder f_{SHenc}. It is to learn from an encoder a relationship between a depth map and an image according to a camera view that may not be learned when an input image and a depth map are independently input to an encoder according to a camera view defined in a basic assumption described above. Since extracted F_{SH} is concatenated to a first pixel-aligned 2D feature map corresponding to n camera views, it may be separated into F_{SH}¹, F_{SH}², . . . , F_{SH}ⁿ to obtain n first pixel-aligned 2D feature maps. Separated 2D feature maps may be transformed into first improved 2D feature maps \tilde{F}_{SH}¹, \tilde{F}_{SH}², . . . , \tilde{F}_{SH}ⁿ through feature-improved multi-layer perceptrons (MLP) f_{RF}¹, f_{RF}², . . . , f_{RF}ⁿ specialized for each camera view. It may be expressed as in the following Equation.

$${\tilde{F}}_{SH}^{1} = {f}_{RF}^{1} ( B ( {F}_{SH}^{1} , π ( x ) ) ) , \qquad [ Equation 9 ]$$

$${\tilde{F}}_{SH}^{2} = {f}_{RF}^{2} ( B ( {F}_{SH}^{2} , π ( x ) ) ) ,$$

$$⋮$$

$${\tilde{F}}_{SH}^{n} = {f}_{RF}^{n} ( B ( {F}_{SH}^{n} , π ( x ) ) )$$

Here, x corresponds to a 3D query coordinate, π(⋅) corresponds to 2D projection corresponding to each camera view and B(⋅) means bilinear interpolation.

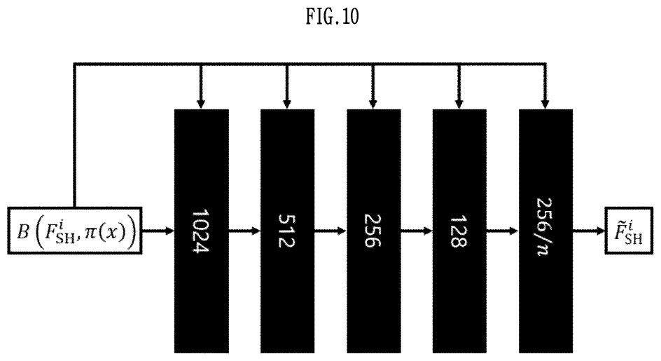

FIG. 10 is a diagram showing an example of a structure of a feature-improved MLP.

Iⁿ an example of FIG. 10, a structure of a feature-improved multi-layer perceptron (MLP) f_{RF}ⁱ specialized for a i-th camera view may be a MLP structure composed of 5 layers. All layers may be composed in a skip connection structure in which an input value is input again. A final dimension of a first improved 2D feature map may be determined as 256/n by n, the number of input images. Accordingly, even when the number of input images increases, a dimension of a multi-layer perceptron that performs occupancy prediction may remain constant. The number of layers is exemplary, and a MLP may be composed of less layers or more layers according to a value of n.

As in the following Equation, F_{2D_OCC} generated by fusing first improved 2D feature maps \tilde{F}_{SH}¹, \tilde{F}_{SH}², . . . , \tilde{F}_{SH}ⁿ may be finally used as a 2D feature map for occupancy prediction.

$${F}_{2 {D}_{OCC}} = {\tilde{F}}_{SH}^{1} ⊕ {\tilde{F}}_{SH}^{2} ⊕ … ⊕ {\tilde{F}}_{SH}^{n} \qquad [ Equation 10 ]$$

Here, ⊕ refers to a concatenation operator.

As in the following Equation, a 3D volume V may be transformed into a first voxel-aligned 3D feature map F_{3D_OCC} by a first 3D feature extraction unit (130) (e.g., a 3D encoder f_{3Denc}).

$${F}_{3 {D}_{OCC}} = {f}_{3 {D}_{enc}} ( V ) \qquad [ Equation 11 ]$$

Next, a first pixel-aligned 2D feature map F_{2D_OCC} and a first voxel-aligned 3D feature map F_{3D_OCC} may be input to an occupancy prediction multi-layer perceptron f_{OCC} with a 3D query coordinate x as in the following Equation and may be used to predict an occupancy probability at a corresponding position.

$${f}_{OCC} ( {λ}_{2} \times {F}_{2 {D}_{OCC}} , {λ}_{1} \times T ( {F}_{3 {D}_{OCC}} , x ) ) ↦ [ 0 , 1 ] \qquad [ Equation 12 ]$$

Here, T(⋅) refers to trilinear interpolation. In addition, as a learnable parameter, λ₁ and λ₂ play a role in determining how much a 2D feature map F_{2D_OCC} and a 3D feature map F_{3D_OCC} will be used for learning or in determining importance and its initial value may be set to 1. An occupancy prediction network of an occupancy prediction unit (140) may be learned to output 1 when a corresponding query is estimated to be inside a human object and to output 0 when it is estimated to be outside a human object. A mesh predicted in an occupancy prediction unit (140) is textureless and may be transformed into a flattened mesh through a flattening unit.

A first 2D feature extraction unit (120) related to an occupancy prediction unit (140) as described above may extract a first pixel-aligned 2D feature map F_{SH} for occupancy prediction extracted without a limit on the number of input images, and may concatenate all of multiple images in extraction and input them into a 2D encoder to learn a relationship between each image that may not be obtained from a single image input. In addition, an occupancy prediction unit (140) may improve a 2D feature map F_{SH} in a direction that may be more helpful for occupancy prediction through a feature-improved multi-layer perceptron specialized for each camera view. Since a dimension of improved 2D feature maps \tilde{F}_{SH}¹, \tilde{F}_{SH}², . . . , \tilde{F}_{SH}ⁿ is designed to be determined by the number of input images, occupancy prediction may be performed flexibly regardless of the number of input images. In occupancy prediction, instead of using a 2D feature map F_{2D_OCC} and a 3D feature map F_{3D_OCC} as a simple input, learnable parameters λ₁ and λ₂ may be used to make more use of more important feature maps.

### Texture Prediction

A second 2D feature map F_{CG} used in a texture prediction unit (170) according to the present disclosure may be obtained based on n input images I¹, I², . . . , Iⁿ and n estimated depth maps D¹, D², . . . , Dⁿ by a second 2D feature extraction unit (150) (e.g., through a 2D encoder f_{CGenc} of CycleGAN) as in the following Equation.

$${F}_{CG} = {f}_{{CG}_{enc}} ( {I}^{1} , {I}^{2} , … , {I}^{n} , {D}^{1} , {D}^{2} , … , {D}^{n} ) \qquad [ Equation 13 ]$$

Similar to an occupancy prediction unit (140), a texture prediction unit (170) may separate a second 2D feature map F_{CG} into F_{CG}¹, F_{CG}², . . . , F_{CG}ⁿ and obtain a second 2D feature map F_{2D_TEX} by fusing a second improved 2D feature map through feature-improved multi-layer perceptrons \acute{f}_{RF}¹, \acute{f}_{RF}², . . . , \acute{f}_{RF}ⁿ specialized for each camera view as in the following Equation.

$${\tilde{F}}_{CG}^{1} = {{f}^{'}}_{RF}^{1} ( B ( {F}_{CG}^{1} , π ( x ) ) ) , \qquad [ Equation 14 ]$$

$${\tilde{F}}_{CG}^{2} = {{f}^{'}}_{RF}^{2} ( B ( {F}_{CG}^{2} , π ( x ) ) ) ,$$

$$⋮$$

$${\tilde{F}}_{CG}^{n} = {{f}^{'}}_{RF}^{n} ( B ( {F}_{CG}^{n} , π ( x ) ) )$$

Here, x corresponds to a 3D query coordinate, π(⋅) corresponds to 2D projection corresponding to each camera view and B(⋅) means bilinear interpolation.

F_{2D_TEX} generated by fusing second improved 2D feature maps \tilde{F}_{CG}¹, \tilde{F}_{CG}², . . . , \tilde{F}_{CG}ⁿ may be obtained as in the following Equation.

$${F}_{2 {D}_{TEX}} = {\tilde{F}}_{CG}^{1} ⊕ {\tilde{F}}_{CG}^{2} ⊕ … ⊕ {\tilde{F}}_{CG}^{n} \qquad [ Equation 15 ]$$

Here, \acute{f}_{RF} corresponds to a multi-layer perceptron with a structure equal or similar to f_{RF} of an occupancy prediction unit (140).

F_{2D_TEX} is not finally used as a 2D feature map for texture prediction, but as in the following Equation, F_{2D_FIN} generated by fusing a first 2D feature map F_{2D_OCC} and a second 2D feature map F_{2D_TEX} generated for occupancy prediction in an occupancy prediction unit (140) may be finally used as a 2D feature map for texture prediction.

$${F}_{2 {D}_{FIN}} = {F}_{2 {D}_{OCC}} ⊕ {F}_{2 {D}_{TEX}} \qquad [ Equation 16 ]$$

Meanwhile, an input multi-view color image is backprojected onto a 3D space through a color image backprojection unit (155), and a result thereof may be input to a second 3D feature extraction unit (160) (e.g., a 3D encoder) to output a 3D feature map F_{3D_TEX}.

F_{2D_FIN} generated as described above and F_{3D_TEX} generated in a second 3D feature extraction unit (160) may be used to predict texture through a texture prediction multi-layer perceptron f_{TEX} as in the following Equation.

$${f}_{TEX} ( {F}_{2 {D}_{FIN}} , T ( {F}_{3 {D}_{TEX}} , x ) ) ↦ [ \hat{C} , λ , Ω ] , \qquad [ Equation 17 ]$$

Here, Ĉ∈ [symbol] ³ refers to a color predicted by a multi-layer perceptron f_{TEX}, i.e., a predicted RGB value. λ corresponds to a first combining parameter. Ω∈ [symbol] ⁿ corresponds to a union of n learnable second combining parameters ω₁, ω₂, . . . , ωₙ.

Input color images I¹, I², . . . , Iⁿ may be transformed into [symbol] , [symbol] , . . . , [symbol] through bilinear interpolation as in the following Equation.

$$= B ( {I}^{1} , π ( x ) ) , \qquad [ Equation 18 ]$$

$$= B ( {I}^{2} , π ( x ) ) ,$$

$$⋮$$

$$= B ( {I}^{n} , π ( x ) )$$

As in the following Equation, [symbol] , [symbol] , . . . , [symbol] may be linearly combined through predicted second combining parameters ω1, ω2, . . . , ωn and calculated as an observed color C.

$$C = {ω}_{1} * + {ω}_{2} * + … + {ω}_{n} * \qquad [ Equation 19 ]$$

Here, C∈ [symbol] ³ refers to a RGB value obtained (i.e., observed) from an input color image. Predicted second combining parameters ω1, ω2, . . . , ωn may be configured to add up to 1 through a softmax function. Finally, as in the following Equation, a predicted color C and an observed color C may be linearly combined through a predicted first combining parameter λ and calculated as a final texture C_{fin}.

$${C}_{fin} = λ * C + ( 1 - λ ) * \hat{C} \qquad [ Equaiton 20 ]$$

A second 2D feature extraction unit (150) related to a texture prediction unit (170) as described above may extract a second pixel-aligned 2D feature map F_{CG} for occupancy prediction extracted without a limit on the number of input images, similar to a first 2D feature extraction unit (120) related to an occupancy prediction unit (140), and may also learn a relationship between each image that may not be obtained from a single image input by concatenating all of the multiple images during extraction and inputting them into a 2D encoder. In addition, a texture prediction unit (170) may obtain second improved 2D feature maps \tilde{F}_{CG}¹, \tilde{F}_{CG}², . . . , \tilde{F}_{CG}ⁿ in which a 2D feature map F_{CG} is improved in a direction that may further help texture prediction through a feature-improved multi-layer perceptron specialized for each camera view. In addition, by learning a parameter corresponding to each input image, an input image at the most useful view may be utilized in texture prediction.

According to examples of the present disclosure, the existing single image-based operation may be expanded by a multi-view image-based 3D model reconstruction method and device for more accurate 3D human mesh reconstruction, solving reconstruction failure problems for an invisible view that have not been solved by the existing single image-based methods.

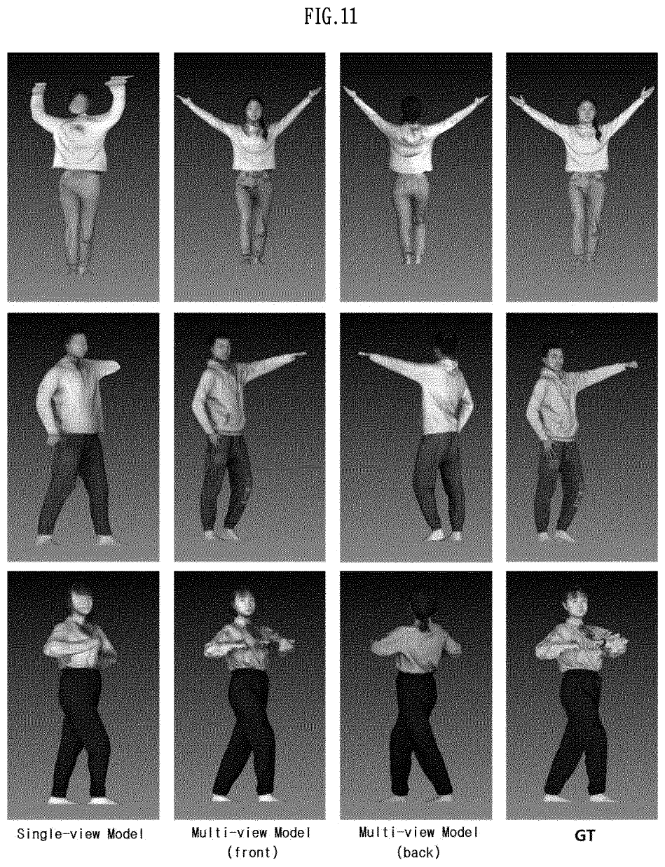

FIG. 11 is a diagram showing examples of a qualitative result of multi-view image-based three-dimensional model estimation/reconstruction according to the present disclosure.

In FIG. 11, it may be confirmed that a pixel alignment feature is actively utilized through a 2D feature map obtained through a MLP for each view and a 3D volume estimated based on a network from a multi-view depth map is utilized as prior information for mesh reconstruction to improve the accuracy of a 3D volume.

A MLP for each view may be used to extract a feature map specialized for each view. In addition, a domain gap may be solved by using a method for fusing a pixel alignment feature with a voxel alignment feature when combining a 2D feature map and a 3D feature map.

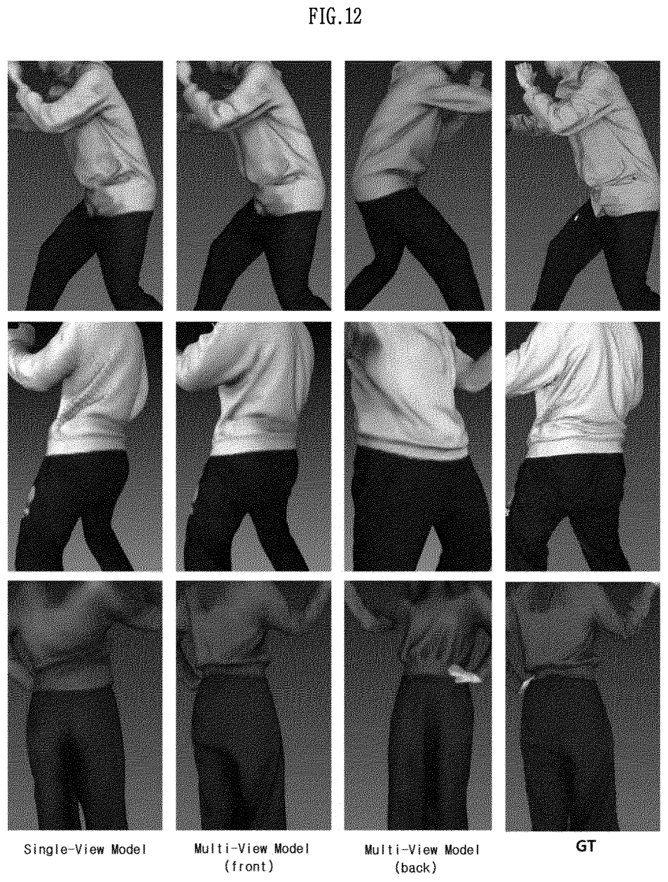

FIG. 12 is a diagram showing examples in which the improvement of a detailed feature may be confirmed from a qualitative result of multi-view image-based three-dimensional model estimation/reconstruction according to the present disclosure.

In FIG. 12, it may be confirmed that compared to the existing single-view models, an improved reconstruction result was achieved especially for a covered part and estimation performance for detailed expressions such as a clothing material, a wrinkle, etc. and the overall posture was also improved.

A component described in illustrative embodiments of the present disclosure may be implemented by a hardware element. For example, the hardware element may include at least one of a digital signal processor (DSP), a processor, a controller, an application-specific integrated circuit (ASIC), a programmable logic element such as a FPGA, a GPU, other electronic device, or a combination thereof. At least some of functions or processes described in illustrative embodiments of the present disclosure may be implemented by software and software may be recorded in a recording medium. A component, a function and a process described in illustrative embodiments may be implemented by a combination of hardware and software.

A method according to an embodiment of the present disclosure may be implemented by a program which may be performed by a computer and the computer program may be recorded in a variety of recording media such as a magnetic Storage medium, an optical readout medium, a digital storage medium, etc.

A variety of technologies described in the present disclosure may be implemented by a digital electronic circuit, a computer hardware, a firmware, a software or a combination thereof. The technologies may be implemented by a computer program product, i.e., a computer program tangibly implemented on an information medium or a computer program processed by a computer program (e.g., a machine readable storage device (e.g.: a computer readable medium) or a data processing device) or a data processing device or implemented by a signal propagated to operate a data processing device (e.g., a programmable processor, a computer or a plurality of computers).

Computer program(s) may be written in any form of a programming language including a compiled language or an interpreted language and may be distributed in any form including a stand-alone program or module, a component, a subroutine, or other unit suitable for use in a computing environment. A computer program may be performed by one computer or a plurality of computers which are spread in one site or multiple sites and are interconnected by a communication network.

An example of a processor suitable for executing a computer program includes a general-purpose and special-purpose microprocessor and one or more processors of a digital computer. Generally, a processor receives an instruction and data in a read-only memory or a random access memory or both of them. A component of a computer may include at least one processor for executing an instruction and at least one memory device for storing an instruction and data. In addition, a computer may include one or more mass storage devices for storing data, e.g., a magnetic disk, a magnet-optical disk or an optical disk, or may be connected to the mass storage device to receive and/or transmit data. An example of an information medium suitable for implementing a computer program instruction and data includes a semiconductor memory device (e.g., a magnetic medium such as a hard disk, a floppy disk and a magnetic tape), an optical medium such as a compact disk read-only memory (CD-ROM), a digital video disk (DVD), etc., a magnet-optical medium such as a floptical disk, and a ROM (Read Only Memory), a RAM (Random Access Memory), a flash memory, an EPROM (Erasable Programmable ROM), an EEPROM (Electrically Erasable Programmable ROM) and other known computer readable medium. A processor and a memory may be complemented or integrated by a special-purpose logic circuit.

A processor may execute an operating system (OS) and one or more software applications executed in an OS. A processor device may also respond to software execution to access, store, manipulate, process and generate data. For simplicity, a processor device is described in the singular, but those skilled in the art may understand that a processor device may include a plurality of processing elements and/or various types of processing elements. For example, a processor device may include a plurality of processors or a processor and a controller. In addition, it may configure a different processing structure like parallel processors. In addition, a computer readable medium means all media which may be accessed by a computer and may include both a computer storage medium and a transmission medium.

The present disclosure includes detailed description of various detailed implementation examples, but it should be understood that those details do not limit a scope of claims or an invention proposed in the present disclosure and they describe features of a specific illustrative embodiment.

Features which are individually described in illustrative embodiments of the present disclosure may be implemented by a single illustrative embodiment. Conversely, a variety of features described regarding a single illustrative embodiment in the present disclosure may be implemented by a combination or a proper sub-combination of a plurality of illustrative embodiments. Further, in the present disclosure, the features may be operated by a specific combination and may be described as the combination is initially claimed, but in some cases, one or more features may be excluded from a claimed combination or a claimed combination may be changed in a form of a sub-combination or a modified sub-combination.

Likewise, although an operation is described in specific order in a drawing, it should not be understood that it is necessary to execute operations in specific turn or order or it is necessary to perform all operations in order to achieve a desired result. In a specific case, multitasking and parallel processing may be useful. In addition, it should not be understood that a variety of device components should be separated in illustrative embodiments of all embodiments and the above-described program component and device may be packaged into a single software product or multiple software products.

Illustrative embodiments disclosed herein are just illustrative and do not limit a scope of the present disclosure. Those skilled in the art may recognize that illustrative embodiments may be variously modified without departing from a claim and a spirit and a scope of its equivalent.

Accordingly, the present disclosure includes all other replacements, modifications and changes belonging to the following claim.

What is claimed:

1. A method for reconstructing a three-dimensional model, the method comprising:
obtaining n (n>1) multi-view images, and a first two-dimensional feature map and a first three-dimensional feature map, based on and n depth maps for the n multi-view images;
estimating a mesh through an occupancy prediction based on the first two-dimensional feature map and the first three-dimensional feature map; and
applying a texture estimated based on a second two-dimensional feature map and a second three-dimensional feature map obtained based on the n multi-view images and the n depth maps to the estimated mesh to obtain a texture-applied final model.

2. The method of claim 1, wherein:
the first two-dimensional feature map corresponds to n first improved two-dimensional feature maps based on n first pixel-aligned two-dimensional feature maps extracted based on the n multi-view images and the n depth maps.

3. The method of claim 2, wherein:
the n first improved two-dimensional feature maps is obtained through a feature-improved multi-layer perceptron for a i-th view, for each i (1≤i≤n)-th first pixel-aligned two-dimensional feature map of the n first pixel-aligned two-dimensional feature maps.

4. The method of claim 3, wherein:
an input of the feature-improved multi-layer perceptron for the i-th view corresponds to a bilinear interpolation result for:
a i-th first pixel-aligned two-dimensional feature map; and
a two-dimensional projection π(x) corresponding to a i-th view for a three-dimensional query coordinate x,
a final dimension of each of the n first improved two-dimensional feature maps is determined equally as 256/n.

5. The method of claim 1, wherein:
the first three-dimensional feature map corresponds to:
a three-dimensional volume estimated through a depth map backprojection based on the n multi-view images and the n depth maps; and
a first voxel-aligned three-dimensional feature map transformed through a first three-dimensional feature extraction for the estimated three-dimensional volume.

6. The method of claim 5, wherein:
the depth map backprojection includes:
performing a deconvolution on an image feature map based on the n multi-view images and the n depth maps;
obtaining a three-dimensional image feature map through a repetition and a concatenation for an image feature map to which the deconvolution is applied; and
estimating the three-dimensional volume through a three-dimensional convolution for the three-dimensional image feature map.

7. The method of claim 5, wherein:
a predetermined number of points are extracted from the estimated three-dimensional volume, and the first voxel-aligned three-dimensional feature map is obtained based on the predetermined number of points.

8. The method of claim 1, wherein:
the occupancy prediction includes outputting a value estimating whether a three-dimensional query coordinate x is inside or outside the three-dimensional model through an occupancy prediction multi-layer perceptron based on:
a two-dimensional feature map for an occupancy prediction in which the n first improved two-dimensional feature maps are fused; and
the first three-dimensional feature map.

9. The method of claim 1, wherein:
the first two-dimensional feature map includes a geometric feature for the n multi-view images and the n depth maps,
the second two-dimensional feature map includes a texture-related feature for the n multi-view images and the n depth maps,
the first three-dimensional feature map is obtained based on a textureless three-dimensional volume,
the second three-dimensional feature map is obtained based on a textured three-dimensional volume.

10. The method of claim 1, wherein:
the n depth maps are estimated based on:
the n multi-view images; and
a mesh estimated based on a first image among the n multi-view images.

11. A method for reconstructing a three-dimensional model, the method comprising:
obtaining n (n>1) multi-view images, and a second two-dimensional feature map and a second three-dimensional feature map, based on and n depth maps for the n multi-view images;
estimating a texture through a texture prediction based on the second two-dimensional feature map and the second three-dimensional feature map; and
applying the estimated texture to a mesh estimated based on a first two-dimensional feature map and a first three-dimensional feature map obtained based on the n multi-view images and the n depth maps to obtain a texture-applied final model.

12. The method of claim 11, wherein:
the second two-dimensional feature map corresponds to n improved two-dimensional feature maps based on n second pixel-aligned two-dimensional feature maps extracted based on the n multi-view images and the n depth maps.

13. The method of claim 12, wherein:
the n second improved two-dimensional feature maps are obtained through a feature-improved multi-layer perceptron for a i-th view for each i (1≤i≤n)-th second pixel-aligned two-dimensional feature map of the n second pixel-aligned two-dimensional feature maps.

14. The method of claim 13, wherein:
an input of the feature-improved multi-layer perceptron for the i-th view corresponds to a bilinear interpolation result for:
a i-th second pixel-aligned two-dimensional feature map; and
a two-dimensional projection π(x) corresponding to a i-th view for a three-dimensional query coordinate x,
a final dimension of each of the n second improved two-dimensional feature maps is determined equally as 256/n.

15. The method of claim 11, wherein:
the second three-dimensional feature map corresponds to:
a color three-dimensional volume estimated through a color image backprojection based on the n multi-view images and the n depth maps; and
a second voxel-aligned three-dimensional feature map transformed through a second three-dimensional feature extraction for the estimated color three-dimensional volume.

16. The method of claim 12, wherein:
a two-dimensional feature map for a texture prediction is obtained by fusing:
a feature map in which the n second improved two-dimensional feature maps are fused; and
a two-dimensional feature map for an occupancy prediction in which n first improved two-dimensional feature maps are fused.

17. The method of claim 16, wherein:
the texture prediction includes obtaining a predicted red green blue (RGB) value for a three-dimensional query coordinate x, a first combining parameter λ, and a union of n second combining parameters ω₁, ω₂, . . . , ωₙ through a texture prediction multi-layer perceptron based on:
the two-dimensional feature map for the texture prediction; and
the second three-dimensional feature map.

18. The method of claim 17, wherein:
the estimated texture is obtained, through the first combining parameter A, by linearly combining:
the predicted RGB value; and
an observed RGB value obtained based on the n multi-view images and the n second combining parameters ω₁, ω₂, . . . , ωₙ.

19. A device for reconstructing a three-dimensional model, the device comprising:
at least one processor; and
at least one memory operably connected to the at least one processor, and storing an instruction to make the device perform an operation when executed by the at least one processor,
wherein the operation includes:
obtaining n (n>1) multi-view images, and a first two-dimensional feature map and a first three-dimensional feature map, based on n depth maps for the n multi-view images;
estimating a mesh through an occupancy prediction based on the first two-dimensional feature map and the first three-dimensional feature map; and
applying a texture estimated based on a second two-dimensional feature map and a second three-dimensional feature map obtained based on the n multi-view images and the n depth maps to the estimated mesh to obtain a texture-applied final model.
